(19) United States
(12) Patent Application Publication
(10) Pub. No.: US 2005/0079990 A1
(43) Pub. Date: Apr. 14, 2005

(54) Cleaning compositions with both viscous and elastic properties

(76) Inventors: Stephen Chan, Pleasanton, CA (US); Stephen B. Kong, Pleasanton, CA (US)

Correspondence Address: THE CLOROX COMPANY, 1221 BROADWAY PO BOX 2351, OAKLAND, CA, 94623, US

(21) Appl. No.: 10/683,210

(22) Filed: Oct. 10, 2003

(51) Int. Cl. C11D 3/00

(52) U.S. Cl. 510/438

(57) ABSTRACT

A thickened bleach composition that is both viscous and elastic. The composition provides the benefits of both Theological characteristics. The composition has utility as a drain opening composition or as a hard or soft surface cleaner having a cleaning-effective residence time on non-horizontal surfaces. The composition preferably has a relative elasticity less than 10 sec/Pa and a 0 Hertz viscosity greater than 1500 cP. The composition also preferably has a relaxation time of 1 second or greater and a static shear modulus greater than 2 Pa.

### FIELD OF THE INVENTION

The present invention relates to thickened bleach compositions, having both viscous and elastic properties, and in particular to thickened bleach compositions which are formulated to have utility as drain cleaners, hard surface cleaners, or soft surface cleaners.

### BACKGROUND OF THE INVENTION

Much art has addressed the problem of developing a thickened cleaning composition, which may contain a bleach and may have utility as a hard surface cleaner. Drain cleaners of the art have been formulated with a variety of actives in an effort to remove the variety of materials, which can cause clogging or restriction of drains. The efficacy of such compositions is greatly improved by viscous formulations, increasing the residence time of the cleaner. Viscous formulations are especially effective on partially clogged drains. Binary formulations in separate compartments, as described in U.S. Pat. No. 6,583,103 to Klinkhammer, U.S. Pat. No. 6,479,444 to Porticos et al., U.S. patent application Ser. No. 2002/0115579 to Ajmani et al., U.S. patent application Ser. No. 2003/0114340 to Ajmani et al., and U.S. patent application Ser. No. 2003/0171234 to Ajmani et al.,contain a bleach composition in one compartment and a composition in another compartment that reacts with the bleach to produce foam. These two compositions mix in the drain to produce a vigorous foam that is effective in treating partially clogged drains. U.S. Pat. No. 4,900,467 to Smith discloses a drain cleaner composition that is highly elastic and travels rapidly through standing water with little dilution, improving the efficacy of the cleaner for fully clogged drains.

The compositions of the present invention combine both viscous and elastic properties. Prior art elastic compositions are effective on full drain clogs. The elastic components hold the solution together so that it will travel through standing water with very little dilution, delivering a high percentage of active to the clog. The elasticity results in a higher delivery rate of active than a purely viscous solution of the same viscosity. However, elastic compositions yield decreased percolation times through porous or partial clogs, so that contact time between the actives and the partial clog is shortened and the breakdown of the partial clog is not as effective. An ideal drain cleaner would combine the efficacy on both full and partial clogs.

Advantageously, the compositions of the invention are also suitable for the bleaching of different types of surfaces including hard-surfaces like floors, walls, tills, glass, kitchen surfaces, bathrooms surfaces, toilet bowls and/or dishes and the like as well as fabrics.

### SUMMARY OF THE INVENTION

In accordance with the above objects and those that will be mentioned and will become apparent below, one aspect of the present invention comprises a thickened bleach composition having a relative elasticity less than 10 sec/Pa and a 0 Hertz viscosity greater than 1500 cP.

In accordance with the above objects and those that will be mentioned and will become apparent below, another aspect of the present invention comprises a thickened bleach composition having a relaxation of 1 second or greater and a static shear modulus greater than 2 Pa.

In accordance with the above objects and those that will be mentioned and will become apparent below, another aspect of the present invention comprises a method of cleaning drains comprising introducing into the drain an effective amount of a liquid drain cleaner consisting essentially of a thickened bleach composition having a relative elasticity less than about 10 sec/Pa and a 0 Hertz viscosity greater than about 1500 cP.

### DETAILED DESCRIPTION OF THE INVENTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the cleaning composition alone, not accounting for the substrate weight. Each of the noted cleaner composition components and substrates is discussed in detail below.

It should be noted that as used herein the term “cleaning” refers generally to a chemical, physical or enzymatic treatment resulting in the reduction or removal of unwanted material, and “cleaning composition” specifically includes drain openers, hard and soft surface cleaners and bleaching compositions. The cleaning composition may consist of a variety of chemically, physically or enzymatically reactive active ingredients, including solvents, acids, bases, oxidants, reducing agents, enzymes, detergents and thioorganic compounds. Unless otherwise specified, all ingredient percentages are weight percentages.

The bleaching composition may be in any form, but are preferably in liquid form. Preferably, the compositions of the invention are in liquid aqueous form. More preferably, they comprise water in an amount of from 60% to 98% by weight, more preferably of from 80% to 97% and most preferably of from 85% to 97% by weight of the total aqueous liquid bleaching composition.

Rheology

The compositions of the present invention depart from compositions of the prior art in that both elasticity and viscosity are crucial parameters to the success of the invention. Elasticity causes the stream to break apart and snap back into the bottle at the end of pouring instead of forming syrupy streamers. Instruments capable of performing oscillatory or controlled stress creep measurements can be used to quantify elasticity. Some parameters can be measured directly (see Hoffmann and Rehage, Surfactant Science Series, 1987, Vol. 22, 299-239), or they can be calculated using models.

The rheology of the inventive compositions was measured with a Bolin VOR rheometer at 77.degree. F. in the oscillatory mode. A frequency sweep with a Bohlin rheometer can produce oscillation data which, when applied to a Maxwell model, result in parameters such as relaxation time (Tau) and static shear modulus (G0). Since the static shear modulus is a measure of the resistance to flow, the ratio of the relaxation time (Tau) to the static shear modulus (G0) is used to measure relative elasticity. The viscosity is the in-phase component extrapolated to 0 Hertz. Tau can also be calculated by taking the inverse of the frequency with the maximum loss modulus. G0 is then obtained by dividing the complex viscosity by Tau.

The relative elasticity is preferably less than 10 sec/Pa and more preferably less than 5 sec/Pa. The 0 Hertz viscosity is preferably greater than 1500 cP and more preferably greater than 2000 cP. The relaxation time is preferably 1 second or greater and more preferably greater than 3 seconds. The static shear modulus is preferably greater that 2 Pa and more preferably greater than 3 Pa.

Thickening system

Any known thickening system can be used for the purposes as required herein. Examples of such thickening systems include those based on polymers, in particular polycarboxylic polymers and even more in particular cross-linked polyacrylates such as those marketed by BF Goodrich under the tradename Carbopol.

A thickening system of the current invention comprises an alkyloxylated sulfate or alkyl sulfate surfactant or mixtures thereof, preferably having an alkyl chain of greater than 12 carbon atoms, more preferably from 14 to 20 carbon atoms and most preferably from 14 to 16 carbon atoms. Another thickening system of the current invention comprises a combination of an amphoteric and/or zwitterionic surfactant and a counterion. Other surfactants for use therein are selected from the group consisting of amine oxide, betaine, sulphobetaines and mixtures thereof as described in more detail below. Surfactants of the thickening system may comprise at least one hydrocarbon chain having 12 to 18 carbon atoms. Optional surfactants are hexadecyl dimethyl amine oxide and hexadecyl betaine. The counterion of the thickening system may be selected from the group consisting of aryl and C2-6 carboxylates, aryl and C2-sulphonates, sulfated aryl alcohols and mixtures thereof. Aryl compounds may be based on benzene or naphthalene compounds and may be substituted. Substituents may include alkyl or alkoxy groups of 1-4 carbons, halogens and nitro groups. The counterions may be added in their acid forms and then converted to the salt form in situ or may be directly used in the salt form. Where present the substituent may be located at any position on the ring structure of benzene or naphthalene. However, positions 3 and 4 of the benzene ring are preferred. Counterions include sulphonates and may be selected from the group consisting of cumene, toluene, xylene sulphonate and mixtures thereof. The weight ratio of surfactant to counterion is preferably between 4:1 to 1:2, more preferably between 3:1 to 1:2 and most preferably 2:1 to 1:1. The thickening system is added to the bleach-containing composition in sufficient quantities to achieve the desired rheology. In a preferred embodiment the thickening system is added to the composition at a level of from 0.1% to 10%, more preferably from 0.2% to 5% and most preferably from 0.2% to 3% by weight of the composition.

Surfactants and Counterions

Where present the surfactant may be selected from anionic, nonionic, cationic, zwitterionic, amphoteric and mixtures thereof. In one embodiment of the present invention the surfactant is selected from amphoteric, zwitterionic and mixtures thereof. In another embodiment of the present invention, the surfactant is selected from amine oxide, betaine, sulphobetaine and mixtures thereof.

Suitable anionic surfactants for use herein include alkyl sulphates. Suitable alkyl sulphates for use herein include water-soluble salts or acids of the formula ROSO3M wherein R is a C6-C24 linear or branched, saturated or unsaturated alkyl group, preferably a C8-C20 alkyl group, more preferably a C8-C16 alkyl group and most preferably a C10-C14 alkyl group, and M is H or a cation or ammonium or substituted ammonium. As discussed above, where the surfactant is used as a means of thickening the composition, preferred alkyl sulphates include those having an alkyl chain length of greater than 10 carbon atoms, more preferably from 12 to 20 carbon atoms and most preferably from 12 to 18 carbon atoms. Examples of preferred sulphate surfactants include sodium dodecyl sulphate, sodium tetradecyl sulphate, sodium hexadecyl sulphate. Suitable anionic surfactants for use herein further include alkoxylated sulphate surfactants. Suitable alkoxylated sulphate surfactants for use herein are according to the formula RO(A)MSO3M wherein R is an unsubstituted C6-C24 alkyl, hydroxyalkyl or alkyl aryl group, having a linear or branched C6-C24 alkyl component, preferably a C12-C20 alkyl or hydroxyalkyl, more preferably C12 C18 alkyl or hydroxyalkyl, A is an ethoxy or propoxy or butoxy unit or a mixture lo thereof, m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphates, alkyl butoxylated sulphates as well as alkyl propoxylated sulphates are contemplated herein.

As discussed above, where the surfactant is used as a means of thickening the composition, preferred alkoxylated sulphates include those having an alkyl chain length of greater than 12 carbon atoms, more preferably from 14 to 20 carbon atoms and most preferably from 14 to 16 carbon atoms and from 1 to 20 moles of alkoxy groups, more preferably from 1 to 5 alkoxy groups, more preferably ethoxy groups. Suitable ethoxy sulphate surfactants include sodium dodecyl ethoxy sulphate (ethoxylation degree around 3), sodium tetradecyl ethoxy sulphate (ethoxylation degree around 3), sodium hexadecyl ethoxy sulphate (ethoxylation degree around 4).

Suitable anionic surfactants for use herein further include alkyl aryl sulphates. Suitable alkyl aryl sulphates for use herein include water-soluble salts or acids of the formula ROSO3M wherein R is an aryl, preferably a benzyl, substituted by a C6-C24 linear or branched saturated or unsaturated alkyl group, preferably a C8-C20 alkyl group and more preferably a C10-C16 alkyl group and M is H or a cation, or ammonium or substituted ammonium.

Suitable anionic surfactants for use herein further include alkyl sulphonates. Suitable alkyl sulphonates for use herein include water-soluble salts or acids of the formula RSO3M wherein R is a C6-C20 linear or branched, saturated or unsaturated alkyl group, preferably a C8-C18 alkyl group and more preferably a C14-C17 alkyl group, and M is H or a cation, e.g., an alkali metal cation or ammonium or substituted ammonium.

Suitable anionic surfactants for use herein further include alkyl aryl sulphonates. Suitable alkyl aryl sulphonates for use herein include water-soluble salts or lo acids of the formula RSO3M wherein R is an aryl, preferably a benzyl, substituted by a C6-C20 linear or branched saturated or. unsaturated alkyl group, preferably a C8-C18 alkyl group and more preferably a C9-C14 alkyl group, and M is H or a cation, or ammonium or substituted ammonium.

Suitable anionic surfactants for use herein further include alkoxylated sulphonate surfactants. Suitable alkoxylated sulphonate surfactants for use herein are according to the formula R(A)mSO3M wherein R is an unsubstituted C6-C20 alkyl, hydroxyalkyl or alkyl aryl group, having a linear or branched C6C20 alkyl component, preferably a C12-C20 alkyl or hydroxyalkyl, more preferably C12-C18 alkyl or hydroxyalkyl, A is an ethoxy or propoxy or butoxy unit, m is greater than zero, typically between 0.5 and 6, more preferably between 0.5 and 3, and M is H or a cation, ammonium or substitutedammonium cation. Alkyl ethoxylated sulphonates, alkyl butoxylated sulphonates as well as alkyl propoxylated sulphonates are contemplated herein.

Suitable anionic surfactants for use herein further include C6-C20 alkyl alkoxylated linear or branched diphenyl oxide disulphonate surfactants. Other suitable anionic surfactants for use herein include alkylcarboxylates.

Other anionic surfactants can include salts (including, for example, sodium, potassium, ammonium, and substituted ammonium salts such as mono-, di- and triethanolamine salts) of soap, C8-C24 olefinsulfonates, sulfonated polycarboxylic acids, acyl glycerol sulfonates, fatty oleyl glycerol sulfates, alkyl phenol ethylene oxide ether sulfates, alkyl phosphates, isethionates such as the acyl isethionates, N-acyl taurates, alkyl succinamates and sulfosuccinates, monoesters of sulfosuccinate (especially saturated and unsaturated C12-C18 monoesters) diesters of sulfosuccinate (especially saturated and unsaturated C6-C14 diesters), acyl sarcosinates, sulfates of alkyl polysaccharides such as the sulfates of alkylpolyglucoside (the nonionic nonsulfated compounds being described below), branched primary alkyl sulfates, alkyl polyethoxy carboxylates such as those of the formula RO(CH 2CH20)k CH 2COO-M+ wherein R is a C8-C 22 alkyl, k is an integer from 0 to 10, and M is a soluble salt-forming cation.

Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. 1 and 11 by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Suitable nonionic surfactants for use herein are fatty alcohol ethoxylates and/or propoxylates which are commercially available with a variety of fatty alcohol chain lengths and a variety of ethoxylation degrees. Indeed, the HLB values of such alkoxylated nonionic surfactants depend essentially on the chain length of the fatty alcohol, the nature of the alkoxylation and the degree of alkoxylation.

Surfactant catalogues are available which list a number of surfactants, including nonionics, together with their respective HLB values. The preferred nonionic surfactants are capped i.e. those where, instead of an H at the end of the chain there is an R group, preferably a methyl group. Such surfactants are for example marketed by BASF in the Plurafac range, for example Plurafac LF231.

Suitable amphoteric surfactants for use herein include amine oxides having the following formula R1R2R3NO wherein each of R1, R2 and R3 is independently a saturated substituted or unsubstituted, linear or branched hydrocarbon chains of from 1 to 30 carbon atoms. Preferred amine oxide surfactants to be used according to the present invention are amine oxides having the following formula R1R2R3NO wherein R1 is an hydrocarbon chain comprising from 1 to 30 carbon atoms, preferably from 6 to 20, more preferably from 12 to 18, even more preferably from 14 to 16, and wherein R2 and R3 are independently substituted or unsubstituted, linear or branched hydrocarbon chains comprising from 1 to 4 carbon atoms, preferably from 1 to 3 carbon atoms, and most preferably are methyl groups. R1 may be a saturated substituted or unsubstituted linear or branched hydrocarbon chain. R1 is most preferably C16 alkyl group. Such amine oxides are commercially available from Hoechst and Clariant.

Suitable zwitterionic surfactants for use herein contain both cationic and anionic hydrophilic groups on the same molecule at a relatively wide range of pH's. The typical cationic group is a quaternary ammonium group, although other positively charged groups like phosphonium, imidazolium and sulfonium groups can be used. The typical anionic hydrophilic groups are carboxylates and sulfonates, although other groups like sulfates, phosphonates, and the like can be used. A generic formula for some zwitterionic surfactants to be used herein is R1-N(R2)(R3)R4X— wherein R1 is a hydrophobic group; R2 and R3 are each C1-C4 alkyl, hydroxy alkyl or other substituted alkyl group which can also be joined to form ring structures with the N; R4 is a moiety joining the cationic nitrogen atom to the hydrophilic group and is typically an alkylene, hydroxy alkylene, or polyalkoxy group containing from 1 to 10 carbon atoms; and X is the hydrophilic group which is preferably a carboxylate or sulfonate group. Preferred hydrophobic groups R1 are alkyl groups containing from 1 to 24, preferably from 12 to 18, more preferably 14 to 16 carbon atoms. The hydrophobic group can contain unsaturation and/or substituents and/or linking groups such as aryl groups, amido groups, ester groups and the like. In general, the simple alkyl groups are preferred for cost and stability reasons.

Preferred zwitterionic surfactants include betaine and sulphobetaine surfactants, functionalized betaines such as acyl betaines, alkylamidoalkyldimethyl betaines, alkyl imidazoline alanine betaines, glycine betaines, derivatives thereof and mixtures thereof. Suitable betaine and sulphobetaine surfactants for use herein are the betaine/sulphobetaine and betaine-like detergents wherein the molecule contains both basic and acidic groups which form an inner salt giving the molecule both cationic and anionic hydrophilic groups over a broad range of pH values. Some common examples of these detergents are described in U.S. Pat. Nos. 2,082,275, 2,702,279, 2,255,082, and 5,252,245 incorporated herein by reference. Preferred betaine and sulphobetaine surfactants herein are according to the formula R2R1-N+—(CH2)n-Y—R3 wherein R1 is a hydrocarbon chain containing from 1 to 24 carbon atoms, preferably from 12 to 18, more preferably from 14 to 16, wherein R2 and R3 are hydrocarbon chains containing from 1 to 3 carbon atoms, preferably 1 carbon atom, wherein n is an integer from 1 to 10, preferably from 1 to 6, more preferably is 1, Y is selected from the group consisting of carboxyl and sulfonyl radicals and wherein the sum of R1, R2 and R3 hydrocarbon chains is from 14 to 24 carbon atoms, or mixtures thereof.

Examples of particularly suitable betaine surfactants include C12-C 18 alkyl dimethyl betaine such as coconut-betaine and C10-C16 alkyl dimethyl betaine such as laurylbetaine. Coconutbetaine is commercially available from Seppic under the trade name of Amonyl 2659. Laurylbetaine is commercially available from Albright & Wilson under the trade name Empigen BB/L.

Other specific zwitterionic surfactants have the generic formulas: R1-C(O)—N(R2)-(C(R3)2)n-N(R2)2(+)−(C(R3)2)n-SO3(−) or R1 —C(O)—N(R2)-(C(R3)2)n-N(R2)2(+)-(C(R3)2)n-COO(−) wherein each R1 is a hydrocarbon, e.g. an alkyl group containing from 8 up to 20, preferably up to 18, more preferably up to 16 carbon atoms, each R2 is either a hydrogen (when attached to the amido nitrogen), short chain alkyl or substituted alkyl containing from one to 4 carbon atoms, preferably groups selected from the group consisting of methyl, ethyl, propyl, hydroxy substituted ethyl or propyl and mixtures thereof, preferably methyl, each R3 is selected from the group consisting of hydrogen and hydroxy groups and each n is a number from 1 to 4, preferably from 2 to 3, more preferably 3, with no more than one hydroxy group in any (C(R3)2) moiety. The R1 groups can be branched and/or unsaturated. The R2 groups can also be connected to form ring structures. A surfactant of this type is a C10-C14 fatty acylamidopropylene(hydroxypropylene) sulfobetaine that is available from the Sherex Company under the trade name “Varion CAS sulfobetaine”.

A preferred composition contains a binary surfactant thickener comprising a betaine and anionic counterion. Examples of other preferred surfactants include amine oxides, sarcosinates, taurates and quaternary ammonium compounds.

Operative betaines include the C₁₄₋₁₈ alkyl betaines and C₁₄₋₁₈ alkyl sulfobetaines. Especially preferred is a cetyl dimethyl betaine (CEDB) such as Amphosol CDB (a trademarked product of the Stepan Company), which is about 95% or greater C₁₆, less than 5% C_{12/14} and less than 1% C₁₈. It is noted that when referring to carbon chain lengths of the betaine or any other compound herein, the commercial, polydisperse forms are contemplated (but not required). Thus, a given chain length within the preferred C₁₄₋₁₈ range will be predominately, but not exclusively, the specified length. As used herein in reference to the betaine or sulfobetaine, the term “alkyl” includes both saturated and unsaturated groups. Fully saturated alkyl groups are preferred in the presence of hypochlorite. C₁₀₋₁₈ alkylamido and alkylamino betaines, and sulfobetaines having C₁₄₋₁₈ alkyl, or C₁₀₋₁₈ alkylamino or alkylamido groups, are also suitable for use in the compositions of the present invention.

The betaine is added at levels, which, when combined with the counterion, are thickening effective. Generally about 0.1 to 10.0 weight percent of the betaine is utilized per each of the first and/or second liquid, preferred is to use about 0.1 to 5.0% betaine, and most preferred is about 0.15-2.0 percent betaine.

The counterion is an anionic organic counterion selected from the group consisting of C₂₋₆ alkyl carboxylates, aryl carboxylates, C₂₋₁₀ alkyl sulfonates, aryl sulfonates, sulfated C₂₋₁₀ alkyl alcohols, sulfated aryl alcohols, and mixtures thereof. The aryl compounds are derived from benzene or napthalene and may be substituted or not. The alkyls may be branched or straight chain, and preferred are those having two to eight carbon atoms. The counterions may be added in acid form and converted to the anionic form in situ, or may be added in anionic form. Suitable substituents for the alkyls or aryls are C₁₋₄ alkyl or alkoxy groups, halogens, nitro groups, and mixtures thereof. Substituents such as hydroxy or amine groups are suitable for use with some non-hypochlorite cleaning actives, such as solvents, surfactants and enzymes. If present, a substituent may be in any position on the rings. If benzene is used, the para (4) and meta (3) positions are preferred. In some circumstances the cleaning active itself may be within the class of thickening-effective counterions. For example, some carboxylic acid cleaning actives may be present in both the acid and conjugate base forms, the latter which could serve as the counterion. The C₂₋₆ alkyl carboxylates may act in this manner. The counterion is added in an amount sufficient to thicken and result in a viscoelastic rheology, and preferably between about 0.01 to 10 weight percent. A preferred mole ratio of betaine to counterion depends on the chain length and concentration of the betaine, type of counterion, and the ionic strength of the solution, as well as whether the primary object of the composition is phase stability or viscosity. Using CEDB and sodium xylene sulfonate (SXS), a preferred mole ratio is about 10:1 to 1:3, and more preferred is about 2:1 to 1:2. A preferred weight ratio of CEDB to SXS is about 15:1 to 1:2, and more preferred is 3:1 to 1:1.

Bleach

Bleaching agents, when used, include, but are not limited to, peracids, hypohalite sources, hydrogen peroxide, and/or sources of hydrogen peroxide. A bleach source may be selected from various hypochlorite-producing species, for example, halogen bleaches selected from the group consisting of the alkali metal and alkaline earth salts of hypohalite, haloamines, haloimines, haloimides and haloamides. All of these are believed to produce hypohalous bleaching species in situ. Hypochlorite and compounds producing hypochlorite in aqueous solution are preferred, although hypobromite is also suitable. Representative hypochlorite-producing compounds include sodium, potassium, lithium and calcium hypochlorite, chlorinated trisodium phosphate dodecahydrate, potassium and sodium dicholoroisocyanurate and trichlorocyanuric acid. Organic bleach sources suitable for use include heterocyclic N-bromo and N-chloro imides such as trichlorocyanuric and tribromo-cyanuric acid, dibromo- and dichlorocyanuric acid, and potassium and sodium salts thereof, N-brominated and N-chlorinated succinimide, malonimide, phthalimide and naphthalimide. Also suitable are hydantoins, such as dibromo and dichloro dimethyl-hydantoin, chlorobromodimethyl hydantoin, N-chlorosulfamide (haloamide) and chloramine (haloamine). Particularly preferred in this invention is sodium hypochlorite having the chemical formula NaOCl, in an amount ranging from about 0.1 weight percent to about 15 weight percent, more preferably about 0.2% to 10%, and most preferably about 2.0% to 6.0%. It may be necessary to add a buffer or other alkaline agent to increase the composition pH to above about 10.0, preferably about 12.0 to maintain the storage stability of the composition.

Optional Ingredients

The pH of the liquid compositions according to the present invention, as is, is typically from 10 to 14, more preferably from 12 to 14. The liquid compositions of the invention have a pH of from 7.5 to 13, preferably from 8 to 12, more preferably from 8.5 to 11.5, when diluted into 1 to 500 times its weight of water. The pH range is suitably provided by the hypohalite bleach, which are alkalis and optionally by the pH buffering component if present. However, in addition to these components, a strong source of alkalinity may also optionally be used.

Suitable sources of alkalinity are the caustic alkalis such as sodium hydroxide, potassium hydroxide and/or lithium hydroxide, and/or the alkali metal oxides such as sodium and/or potassium oxide. A preferred strong source of alkalinity is a caustic alkali, more preferably sodium hydroxide and/or potassium hydroxide. Typical levels of such caustic alkalis, when present, are of from 0.1% to 1.5% by weight, preferably from 0.5% to 1.5% by weight of the composition.

The composition according to the invention may comprise other optional components such as pH buffering components, stabilizing agents, other bleach-stable surfactants, builders, thickening agents, polymers, dyes, solvents, perfumes, brighteners, and mixtures thereof.

The compositions according to the present invention may optionally comprise a pH buffering component or mixture thereof. Such a pH buffering component is a highly preferred optional ingredient for the compositions of the invention. The pH buffering component ensures that the pH of the composition is buffered to a pH value ranging from 7.5 to 13, preferably from 8 to 12, more preferably from 8.5 to 11.5 after the composition has been diluted into 1 to 500 times its weight of water. Suitable pH buffering components for use herein are selected from the group consisting of alkali metal salts of carbonates, polycarbonates, sesquicarbonates, silicates, polysilicates, boron salts, phosphates, stannates, alluminates and mixtures thereof. The preferred alkali metal salts for use herein are sodium and potassium.

Suitable boron salts or mixtures thereof for use herein include alkali metal salts of borates and alkyl borates and mixtures thereof. Examples of boron salts include boric acid, alkali metal salts of metaborate, tetraborate, octoborate, pentaborate, dodecaboron, borontrifluoride and alkyl borate containing from 1 to 12 carbon atoms, preferably from 1 to 4. Suitable alkyl borate includes methyl borate, ethyl borate and propyl borate. Particularly preferred boron salts herein are the alkali metal salts of metaborate, such as sodium metaborate, potassium metaborate, and the alkali metal salts of borate, such as sodium borate, or mixtures thereof. Boron salts like sodium metaborate and sodium tetraborate are commercially available from Borax and Societa Chimica Larderello under the names sodium metaborate and Borax.

Preferred pH buffering components are selected from the group consisting of sodium carbonate, sodium silicate, sodium borate, sodium metaborate and mixtures thereof. The raw materials involved in the preparation of hypohalite bleaches usually contain by-products, e.g. calcium carbonate resulting in an amount of up to 0.4% by weight of by-product within the hypohalite composition. However, at such amount, the by-product will not have the buffering action defined above. Liquid bleaching compositions herein preferably contain an amount of pH buffering component of from 0.5% to 9% by weight, preferably from 0.5% to 5% by weight, and more preferably in an amount of from 0.6% to 3% by weight of the composition.

Suitable radical scavengers for use herein include aromatic radical scavengers comprising an unsaturated ring system of from 3 to 20 carbon atoms, preferably of from 3 to 18 and more preferably of from 5 to 14 and having a double bond set comprising a total of 4n+2 electrons, wherein n is an integer of from 0 to 4, preferably of from 1 to 3. Indeed said aromatic radical scavengers include benzene derivatives, naphthalene derivatives, annulene derivatives, cyclopentadiene derivatives, cyclopropene derivatives and the like, especially aryl carboxylates and/or aryl sulfonates.

Viscosity of the compositions herein may be enhanced by including aliphatic and aromatic hydrocarbon oils such as hexadecane and dodecylbenzene.

The composition of the present invention can be formulated to include such components as fragrances, coloring agents, whiteners, solvents, soil release polymers, bacteriocidal agents, chelating agents and builders, which enhance performance, stability or aesthetic appeal of the composition. The composition of the present invention may contain from about 0.01% to about 0.5% of a fragrance such as those commercially available from International Flavors and Fragrance, Inc. Dyes and pigments may be included in small amounts. Ultramarine Blue (UMB) and copper phthalocyanines are examples of widely used pigments which may be incorporated in the composition of the present invention.

The bleaching compositions of the present invention can be used to treat drains. The maximum benefits of the rheology of the cleaning composition of the present invention are attained when the composition is denser than water, enabling it to penetrate standing water. While less dense compositions still benefit from the rheology when applied to drains having porous or partial clogs, the full benefit is obtained when the composition possesses a density greater than water. In many instances, this density is attained without the need for a densifying material. In formulations containing sodium hypochlorite, for example, sufficient sodium chloride is present with the hypochlorite to afford a density greater than water. When necessary to increase the density, a salt such as sodium chloride is preferred and is added at levels of 0 to about 20%.

In the present invention, the bleaching composition can be used to treat surfaces. By “surfaces”, it is meant herein any inanimate surface. These inanimate surfaces include, but are not limited to, hard-surfaces typically found in houses like kitchens, bathrooms, or in car interiors, e.g., tiles, walls, floors, chrome, glass, smooth vinyl, any plastic, plastified wood, table top, sinks, cooker tops, dishes, sanitary fittings such as sinks, showers, shower curtains, wash basins, WCs and the like, as well as fabrics including clothes, curtains, drapes, bed linens, bath linens, table cloths, sleeping bags, tents, upholstered furniture and the like, and carpets. Inanimate surfaces also include household appliances including, but not limited to, refrigerators, freezers, washing machines, automatic dryers, ovens, microwave ovens, dishwashers and so on.

By “treating a surface”, it is meant herein bleaching and/or disinfecting said surfaces as the compositions of the present invention comprise a hypohalite bleach and cleaning, i.e. removing various types of stains from the surfaces.

Thus, the present invention also encompasses a process of treating (e.g. bleaching) a fabric, as the inanimate surface. In such a process a fabric is contacted with a composition according to the present invention. In another embodiment the present invention also encompasses a process of treating a hard surface, as the inanimate surface. In such a process a composition, as defined herein, is contacted with the hard surfaces to be treated. Thus, the present invention also encompasses a process of treating a hard-surface with a composition, as defined herein, wherein said process comprises the step of applying said composition to said hard-surface, preferably only soiled portions thereof, and optionally rinsing said hard surface.

In the process of treating surfaces according to the present invention the composition, as defined herein, may be applied to the surface to be treated in its neat form or in its diluted form typically up to 200 times their weight of water, preferably into 80 to 2 times their weight of water, and more preferably 60 to 2 times.

When used as hard surfaces bleaching/disinfecting compositions the compositions of the present invention are easy to rinse and provide good shine characteristics on the treated surfaces.

### EXAMPLES

Table I shows Inventive Composition A compared to three commercial hypochlorite drain openers. The Inventive Composition A is equal to the commercial elastic drain opener (Comparative Example 1) on clearing standing water clogs. The Inventive Composition A is also equal to the commercial viscous drain openers (Comparative Examples 2 and 3) in the average flow improvement for slow drains.

The standing water clear time is determined by combining 7.5 g of 10% ivory soap solution and 15 g hair clippings into a sudsy homogeneous hair and soap ball. The soap ball is stuffed into the bottom on the p-trap and the p-trap is screwed into the drain assembly. The sink is filled water until sink is full. The clog should only allow a small amount of water to pass. Then pour test formula 32 ounces into the sink basin. Wait for clog to completely clear and record time as the standing water clear time.

The slow drain flow improvement is measured by starting with a clean p-trap and drain stopper assembly. Then weight out 2 g of long-stranded hair (6-8″ long). Separate hairs and place into top of sink basin. Wet hair with water. Stuff all hair into the drain and around stopper using a small plastic spatula. Measure initial flow rate using 2 L of water (typically 2 gpm). Pour test formula 16 ounces into sink basin and allow product to work based on label instructions (typically 15 minutes). Rinse with 7 L of water. Repeat flow rate measurement with 2 L of water.

TABLE I

| | Inventive | Compar- | Compar- | Compar- |
|---|---|---|---|---|
| | Composition A | ative 1^{a} | ative 2^{b} | ative 3^{c} |
| Formula | | | | |
| ingredients | | | | |
| Cetyl betaine^{d} | 1.25% | | | |
| Sodium xylene | 0.875% | | | |
| sulfonate^{e} | | | | |
| NaOCl | 5.8% | 5.8% | 7.0% | 7% |
| NaOH | 1.85% | | | |
| NaSilicate^{f} | 0.11% | | | |
| Water | balance | | | |
| Rheology | | | | |
| Relaxation time, tau | 4.4 | 17.5 | 0.15 | 0.3 |
| (sec) | | | | |
| Go (Pa) | 4.4 | 0.6 | 35 | 30 |
| Relative elasticity, | 1.1 | 39 | 0.004 | 0.01 |
| tau/Go (sec/Pa) | | | | |
| 0 Hz viscosity (cP) | 3095 | 1650 | 780 | 1430 |
| Clog Performance | | | | |
| Standing water | 3-4 | 3 | 12 | 16 |
| Avg. clear time | | | | |
| (min) | | | | |
| Slow drains | 2.6 | 1.3 | 2.6 | 2.5 |
| Avg. flow | | | | |
| improvement | | | | |
| (gal/min) | | | | |

^{a}Commercial elastic drain opener (PSLP)
^{b}Commercial viscous drain opener (Draino Max)
^{c}Commercial viscous drain opener (Drano Gel)
^{d}Stepan Company.
^{e}Stepan Company.
^{f}PQ Corp.

Table II shows alternative formulations of the Inventive Composition.

TABLE II

| | Compo- | Compo- | Compo- | Compo- |
|---|---|---|---|---|
| | sition B | sition D | sition E | sition F |
| Formula ingredients | | | | |
| Cetyl betaine | 0.8% | 0.8% | 1.3% | 1.5% |
| Sodium cumene | 0.6% | | | |
| sulfonateⁱ | | | | |
| Sodium octane | | 0.6% | | |
| sulfonate^{j} | | | | |
| Sodium xylene sulfonate | | | 0.85% | 1.05% |
| NaOCl | 5.8% | 5.8% | 5.8% | 5.8% |
| NaOH | 1.85% | 1.85% | 1.85% | 1.85% |
| NaSilicate | 0.11% | 0.11% | 0.11% | 0.11% |
| Water | balance | balance | balance | balance |
| Rheology | | | | |
| Relaxation time, tau | 4.8 | 3.3 | 8.26 | 2.9 |
| (sec) | | | | |
| Go (Pa) | 2.9 | 2.7 | 4.35 | 6.8 |
| Relative elasticity, | 1.6 | 1.5 | 3.12 | 0.4 |
| tau/Go (sec/Pa) | | | | |
| 0 Hz viscosity (cP) | 2210 | 1440 | 5720 | 3100 |

ⁱSCS from Stepan Company.
^{j}Bioterge PAS-8S from Stepan Company.

These thickened bleach compositions can also be used as hard surface cleaners and to pretreat fabric. Composition A is effective at cleaning floor soil on vinyl tiles by hand with a sponge. Composition A is also effective at cleaning fabric stains. Stained cotton fabric was pretreated for 15 min, gently scrubbed, and then rinsed. Stains effectively removed include grass, tea, red wine, berry juice, coffee, and mustard. Composition A is also effective when added to the laundry.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

1. A thickened bleach composition having a relative elasticity less than about 10 sec/Pa and a 0 Hertz viscosity greater than about 1500 cP.

2. The bleach composition of claim 1 wherein the bleach comprises hypochlorite or a hypochlorite generating species.

3. The bleach composition of claim 2 having a relative elasticity less than about 5 sec/Pa and a 0 Hertz viscosity greater than about 2000 cP.

4. The bleach composition of claim 1 having a relative elasticity less than about 5 sec/Pa and a 0 Hertz viscosity greater than about 2000 cP.

5. The bleach composition of claim 1 having a relative elasticity between about 0.1 and 10 sec/Pa and a 0 Hertz viscosity greater than about 1500 cP.

6. The bleach composition of claim 1, wherein said composition is used as a drain cleaner.

7. The bleach composition of claim 1, wherein said composition is used to clean hard surfaces.

8. The bleach composition of claim 1, wherein said composition is used to clean fabric.

9. A thickened bleach composition having a relaxation of about 1 second or greater and a static shear modulus greater than about 2 Pa.

10. The bleach composition of claim 9, wherein the bleach comprises hypochlorite or a hypochlorite generating species.

11. The bleach composition of claim 10 having a relaxation of about 3 seconds or greater and a static shear modulus greater than about 3 Pa.

12. The bleach composition of claim 9 having a relaxation of about 3 seconds or greater and a static shear modulus greater than about 3 Pa.

13. The bleach composition of claim 9 having a relaxation of about 3 seconds or greater and a static shear modulus greater than about 4 Pa.

14. The bleach composition of claim 9, wherein said composition is used as a drain cleaner.

15. The bleach composition of claim 9, wherein said composition is used to clean hard surfaces.

16. The bleach composition of claim 9, wherein said composition is used to clean fabric.

17. A method of cleaning drains comprising introducing into the drain an effective amount of a liquid drain cleaner consisting essentially of a thickened bleach composition having a relative elasticity less than about 10 sec/Pa and a 0 Hertz viscosity greater than about 1500 cP.

18. The method of cleaning drains of claim 17, wherein the bleach comprises hypochlorite or a hypochlorite generating species.

19. The method of cleaning drains of claim 17, wherein the bleach composition has a 0 Hertz viscosity greater than about 2000 cP.

20. The method of cleaning drains of claim 17, wherein the bleach composition has a relaxation of about 1 second or greater.

21. The method of cleaning drains of claim 17, wherein the bleach composition has a static shear modulus greater than about 3 Pa.
